(19) United States
(12) Patent Application Publication
(10) Pub. No.: US 2024/0050809 A1
(43) Pub. Date: Feb. 15, 2024

(54) APPARATUS FOR PROVIDING GOLF LESSONS

(71) Applicants: GSPI CO., LTD., Daejeon (KR); SBS MEDIANET CO., LTD., Seoul (KR)

(72) Inventors: San Bok LEE, Daejeon (KR); Hong Rak CHOI, Seoul (KR)

(73) Assignees: GSPI CO., LTD., Daejeon (KR); SBS MEDIANET CO., LTD., Seoul (KR)

(21) Appl. No.: 18/257,933

(22) PCT Filed: Oct. 14, 2022
(86) PCT No.: PCT/KR2022/015549

§ 371 Date: Jun. 16, 2023

(30) Foreign Application Priority Data
Nov. 18, 2021 (KR) 10-2021-0159680

(51) Int. Cl. A63B 24/00; A63B 71/06; A63B 37/00

(52) U.S. Cl. CPC A63B 24/0075; A63B 71/0622; A63B 37/0022; A63B 2220/05; A63B 2220/807; A63B 2071/063; A63B 2024/0034; A63B 2102/32

(57) ABSTRACT

Disclosed herein is an apparatus for providing golf lessons including: a camera unit configured to photograph images of a golf ball hit by a user with a golf club; a memory configured to store golf lesson data according to ball flight patterns of the golf ball; and a processor for analyzing the images of the golf ball captured by the camera unit to derive the ball flight patterns, reading the golf lesson data according to the ball flight patterns from the memory, and providing the read golf lesson data to the user.

### TECHNICAL FIELD

The present disclosure relates to an apparatus for providing golf lessons.

### BACKGROUND ART

With the increase in the golf population, the number of golfers who want to take golf lessons is also increasing.

Existing golf lessons were conducted offline by actual instructors, but there were limitations, such as an increase in lesson fees and time, and space constraints.

Accordingly, there is an increasing demand for golf lessons that can overcome temporal and spatial limitations to be suitable for users.

### DISCLOSURE

### Technical Problem

Accordingly, the present invention has been made in view of the above-mentioned problems occurring in the related art, and it is an object of the present invention to provide an apparatus for providing golf lessons to be suitable for users.

The objects of the present disclosure are not limited to those mentioned above, and other objects not mentioned herein will be clearly understood by those skilled in the art from the following description.

### Technical Solution

To accomplish the above-mentioned objects, according to the present invention, there is provided an apparatus for providing golf lessons including: a camera unit configured to photograph images of a golf ball hit by a user with a golf club; a memory configured to store golf lesson data according to ball flight patterns of the golf ball; and a processor for analyzing the images of the golf ball captured by the camera unit to derive the ball flight patterns, reading the golf lesson data according to the ball flight patterns from the memory, and providing the read golf lesson data to the user.

The camera unit photographs images of the golf ball with a marking formed on its surface, and the processor analyzes the images of the golf ball captured by the camera unit to derive the ball flight pattern of the golf ball according to rotation information of the marking.

The processor derives the ball flight patterns of the golf ball according to the movement trajectory of the golf ball and the rotation information of the marking by analyzing the images of the golf ball captured by the camera unit.

The golf lesson data is about lesson contents by an actual professional golfer, and the processor analyzes the images of the golf ball hit by the user to check a change in ball flight pattern of the golf ball after providing the golf lesson data to the user.

In another aspect of the present disclosure, there is provided an apparatus for providing golf lessons further including: a variable plate unit having a plate on which a user and a golf ball is put and an actuator connected with the plate to transform the shape of the plate, wherein the processor controls the shape deformation of the plate by controlling the actuator according to the golf course topography information, and reads golf lesson data according to the golf course topography information from the memory to provide the data to the user.

The camera unit photographs images of the golf ball that the user hits with the golf club on the plate, and the processor derives the trajectory of the golf ball by analyzing the image of the golf ball photographed by the camera unit. The processor reads the golf lesson data according to the golf course topography information and the trajectory of the golf ball from the memory, and provides the data to the user.

The golf course topography information includes information about the intensity of hydraulic pressure or pneumatic pressure applied to a cylinder of the actuator.

The golf lesson data includes golf lesson data using one among pitching wedge, approach wedge, or sand wedge used on the plate by the user.

### DESCRIPTION OF DRAWINGS

FIG. 1 is a view showing an example of an apparatus for providing golf lessons according to an embodiment of the present disclosure;

FIG. 2 shows an example of installation of the apparatus for providing golf lessons according to an embodiment of the present disclosure;

FIG. 3 is a view showing an example of ball flight patterns of a golf ball;

FIG. 4 shows an example of ball flight patterns according to rotation of a marked golf ball;

FIG. 5 is for depicting an example of a trajectory derivation method of a golf ball; and

FIGS. 6 and 7 illustrate a variable plate part of the apparatus for providing golf lessons according to an embodiment of the present disclosure.

### MODE FOR INVENTION

Hereinafter, embodiments of the present disclosure will be described in detail with reference to the accompanying drawings. However, the accompanying drawings are only described in order to more easily disclose the contents of the present disclosure, and it will be easily understood by those of ordinary skill in the art that the scope of the present disclosure is not limited to the scope of the accompanying drawings.

The terms used in the following description are intended to merely describe specific embodiments, but not intended to limit the invention. An expression of the singular number includes an expression of the plural number, so long as it is clearly read differently.

The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

An apparatus for providing golf lessons according to various embodiments of the present disclosure may include at least one among, for example, a smartphone, a tablet personal computer (tablet PC), a mobile phone, a desktop personal computer (desktop PC), a laptop personal computer (laptop PC), a netbook computer, a workstation, a server, a wearable device (e.g., smart glasses, or head-mounted device (HMD)), electronic clothes, and a smart watch.

In some embodiments, the apparatus for providing golf lessons may be a smart home appliance. The smart home appliance may include at least one among, for example, a television, a digital video disk (DVD) player, a blue-ray player, an audio set, a set-top box, a home automation control panel, a security control panel, a TV box (e.g., Samsung HomeSync™, Apple TV™, or Google TV™), and a game console (e.g., Xbox™, PlayStation™).

According to some embodiments, the apparatus for providing golf lessons may include at least one among a portion of a building/structure, an electronic board, an electronic signature receiving device, and a projector. In various embodiments, the apparatus for providing golf lessons may be one or a combination of the various devices described above. The apparatus for providing golf lessons according to an embodiment may be a flexible electronic device. In addition, the apparatus for providing golf lessons according to an embodiment of the present disclosure is not limited to the above devices, and may include a new electronic device according to technological development.

Hereinafter, the apparatus for providing golf lessons according to various embodiments of the present disclosure will be described with reference to the accompanying drawings. In this specification, the term, ‘user’, may refer to a person using the apparatus for providing golf lessons or a device (e.g., an artificial intelligence electronic device) using the apparatus for providing golf lessons.

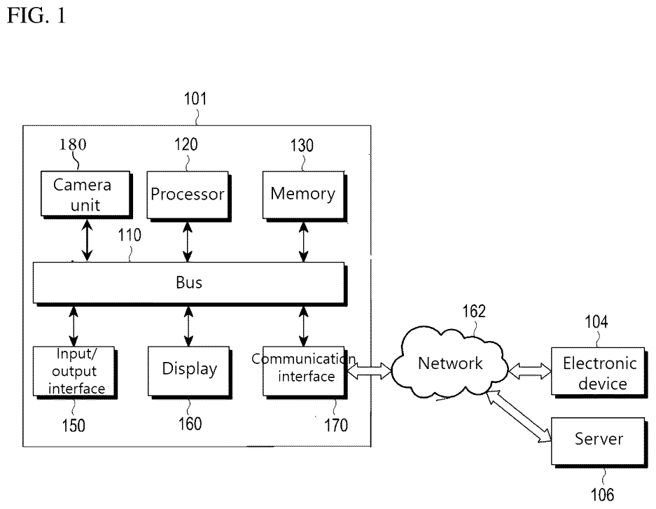

FIG. 1 is a diagram showing an example of the apparatus for providing golf lessons according to an embodiment of the present disclosure. Referring to FIG. 1. In in various embodiments of the present disclosure, the apparatus 101 for providing golf lessons in a network environment is described.

The apparatus 101 for providing golf lessons includes a processor 120 and a memory 130, and may further include at least one of a bus 110, an input/output interface 150, a display 160, and a communication interface 170. In some embodiments, the apparatus 101 for providing golf lessons may omit at least one of the above components or may additionally include other components.

The bus 110 may include, for example, a circuit which connects the components to each other and transfers communication (e.g., control messages and/or data) between the components.

The processor 120 may include one or more among a micro controller unit (MCU), a central processing unit (CPU), and an application processor (AP), and further include one or more among a communication processor (CP), a graphic processing unit (GPU), and a data processing unit (DPU). The processor 120 may, for example, execute calculations or data processing related to control and/or communication of one or more different components of the apparatus 101 for providing golf lessons.

The memory 130 may include a volatile and/or non-volatile memory. For example, the volatile memory may include a RAM, and the non-volatile memory may include at least one among a ROM, an HDD, an ODD, a SDD, and a flash memory, but is not limited thereto.

The memory 130 may, for example, store logic, commands, and data related to one or more different components of the apparatus 101 for providing golf lessons. According to one embodiment, the memory 130 may store software and/or programs 140.

The input/output interface 150 may, for example, serve as an interface capable of transferring commands or data input from a user or other external device to other component(s) of for example. Moreover, the input/output interface 150 may output commands or data received from other component(s) of the apparatus 101 for providing golf lessons to a user or another external device. For example, the input/output interface 150 may be, for example, a serial port, a parallel port, a PS/2, an ADB, an SCSI, an USB, an HDMI, a DVI-I, or a thunderbolt, but is not limited thereto.

The display 160 may be, for example, a liquid crystal display (LCD), a light emitting diode (LED) display, an organic light emitting diode (OLED) display, a microelectromechanical systems (MEMS) display, or an electronic paper display, and a beam projector. The display 160 may display, for example, various types of contents (e.g., texts, images, videos, icons, symbols, etc.) to the user. The display 160 may include a touch screen, and may receive a touch, a gesture, a proximity, or a hovering input using, for example, an electronic pen or a portion of the body of the user.

The communication interface 170 may, for example, set communication between apparatus 101 for providing golf lessons and an external device (e.g., an external electronic device 104 or a server 106). For example, the communication interface 170 may be connected to a network 162 through wireless or wired communication to communicate with the external device (e.g., the external electronic device 104 or the server 106).

The wireless communication may use, for example, at least one among a bluetooth communication protocol, an NFC communication protocol, a ZigBee communication protocol, a Wi-Fi communication protocol, and a cellular communication protocol, but is not limited thereto. The cellular communication protocol may use at least one among, for example, LTE, LTE-A, CDMA, WCDMA, UMTS, WiBro, GSM, and IMT-2020, but is not limited thereto.

The wired communication may include at least one among, for example, a wired LAN card, a universal serial bus (USB), a high definition multimedia interface (HDMI), a recommended standard 232 (RS-232), or a plain old telephone service (POTS), but is not limited thereto.

The network 162 may include at least one among a LAN, a WAN, internet, intranet, a telephone network, a mobile communication network, and a blockchain, but is not limited thereto.

A camera unit 180 may include an imaging device such as a CCD or CMOS to generate digital image data of a subject.

Next, the apparatus 101 for providing golf lessons according to an embodiment of the present disclosure will be described with reference to the drawings.

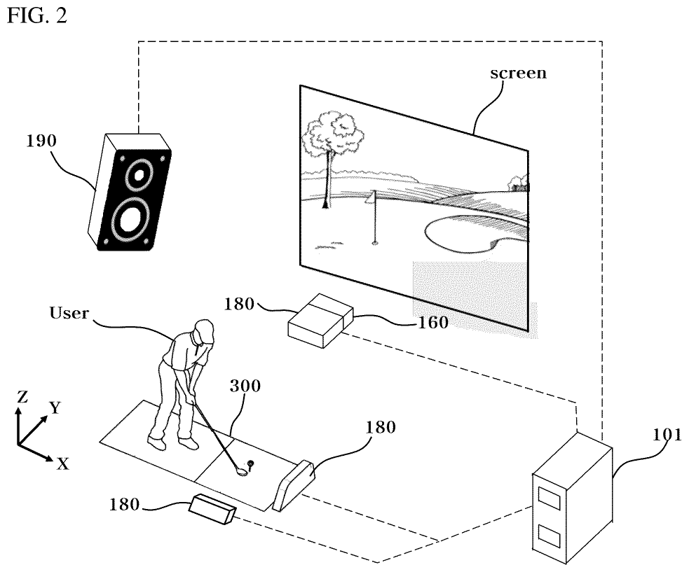

FIG. 2 shows an installation example of the apparatus 101 for providing golf lessons according to an embodiment of the present disclosure. FIG. 2 illustrates that the apparatus 101 for providing golf lessons according to an embodiment of the present disclosure is installed in a screen golf course, but the present disclosure is not limited thereto. For example, the apparatus 101 for providing golf lessons according to an embodiment of the present disclosure may be installed in a golf driving range or a golf fitting center.

The camera unit 180 is configured to photograph images of a golf ball hit by a user with a golf club. A shutter speed of the camera unit 180 may be set to photograph a golf ball flying at high speed. The camera unit 180 may include one camera, or may include a plurality of cameras. In a case in which the camera unit 180 includes a plurality of cameras, the plurality of cameras may be synchronized with each other.

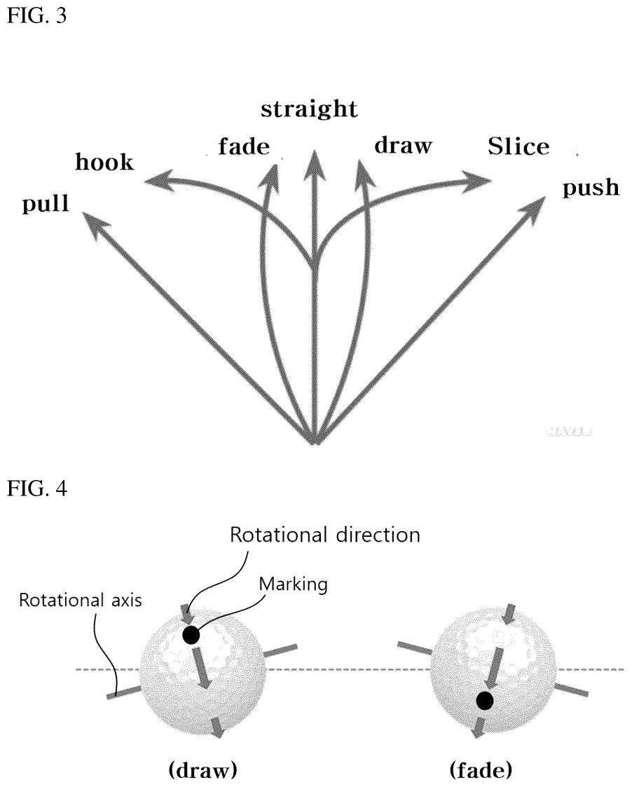

The memory 130 is configured to store golf lesson data according to ball flight patterns of the golf ball. For example, as illustrated in FIG. 3, the movement trajectory of the golf ball may be varied according to the types of the ball flight patterns. The present disclosure is not limited to the ball flight patterns in FIG. 3, and the ball flight patterns in the present disclosure may be less or more than that of FIG. 3.

The ball flight patterns of the golf ball may vary depending on a face angle of a golf club at the moment of impact between the golf club and the golf ball. Since the face angle of the golf club at the moment of impact of the golf ball varies according to the swing trajectory of the user's golf club, golf lesson data according to the ball flight patterns may include golf lesson data for correcting the swing trajectory of the user's golf club.

Such golf lesson data may include at least one of image data and sound data. The image data is displayed through the display described above, and the apparatus 101 for providing golf lessons may further include a speaker 190 for processing sound data.

The processor 120 may access the memory 130 through a bus (110) or remotely access the memory 130 through the communication interface 170.

The processor 120 analyzes the image of the golf ball captured by the camera unit 180 to derive the ball flight patterns, reads the golf lesson data according to the ball flight patterns from the memory 130, and provides the read golf lesson data to the user.

A marking may be formed on the surface of the golf ball in order to derive the ball flight pattern of the golf ball. The marking may be in the form of a dot or a line, but are not limited thereto.

The camera unit 180 photographs images of the golf ball with the marking formed on its surface, and the processor 120 analyzes the images of the golf ball captured by the camera unit 180 to derive the ball flight pattern of the golf ball according to rotation information of the marking.

In a case in which the camera unit 180 generates images of the golf ball at 60 frames per second, the processor 120 may derive the movement of the marking by analyzing the images of the golf ball at 60 frames per second. Since the movement of the marking depends on the rotation of the golf ball, the processor 120 may derive rotation information of the golf ball by deriving the movement of the marking.

In this instance, the rotation information of the golf ball may include information about a rotational direction of the golf ball and information about a rotational axis of the golf ball. Additionally, the rotation information of the golf ball may further include information about the rotational speed of the golf ball.

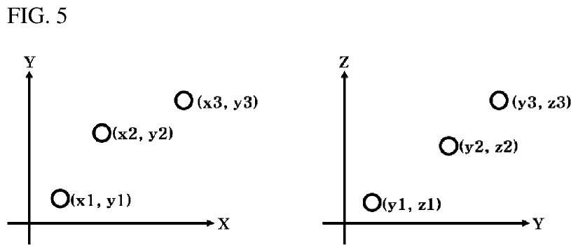

For example, FIG. 4 shows images of a flying golf ball captured from the rear. As illustrated in FIG. 4, it can be seen that the golf ball rotates from top to bottom because the marking moves from top to bottom. In this instance, as illustrated at the left side of FIG. 4, since the movement trajectory of the marking is tilted to the left, the processor 120 may derive that the rotational axis of the golf ball is also tilted to the left.

In addition, as illustrated at the right side of FIG. 4, since the movement trajectory of the marking is tilted to the right, the processor 120 may derive that the rotational axis of the golf ball is tilted to the right.

The processor 120 derives rotation information (for example, information on the rotational direction and the rotational axis) of the golf ball through analysis of the images of the golf ball, and also derives that the ball flight patterns of the golf ball are draw and fade according to the rotation information.

The processor 120 may access the memory 130 to read and process golf lesson data for draw and fade. Through this, the user may be provided with golf lessons on draw and fade.

The processor 120 may select golf lesson data according to the user's desired ball flight pattern and the actual ball flight pattern of the golf ball hit by the user with a golf club. For example, in a case in which the user's desired ball flight pattern is straight and the actual ball flight pattern of the golf ball is fade, the processor 120 may select golf lesson data for correcting fade into straight.

As described above, it has been described that the camera unit 180 generates images of the golf ball at 60 frames per second, but it is just an example, and the camera unit 180 of the present disclosure may generate images at less or more frames per second than 60 frames per second.

In addition, although FIG. 4 shows the ball flight patterns of draw and fade, it is just an example, and the present disclosure is not limited to the ball flight patterns of draw and fade.

Meanwhile, the processor 120 may derive the ball flight patterns of the golf ball according to the movement trajectory of the golf ball and the rotation information of the marking by analyzing the images of the golf ball captured by the camera unit 180.

As described above with reference to FIG. 3, the movement trajectory of the golf ball may vary according to the ball flight patterns of the golf ball. The present disclosure can more accurately derive ball flight patterns of the user by deriving not only the rotation information of the golf ball but also the movement trajectory of the golf ball.

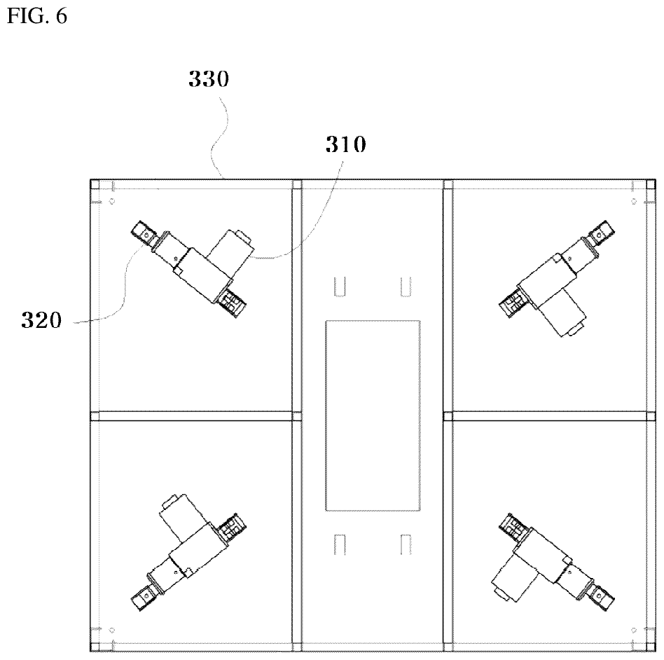

For example, as illustrated in FIG. 5, the camera unit 180 may generate an image of a position change of the golf ball on the X-Y plane and an image of the position change of the golf ball on the Y-Z plane. The image of the X-Y plane may be captured by the camera unit 180 installed on the upper side of the golf ball, such as the ceiling, and the image of the Y-Z plane may be captured by the camera unit 180 installed on one side of the golf ball.

The processor 120 may process the image of the X-Y plane and the image of the Y-Z plane to derive the trajectory of the golf ball through a coordinate change in an X-Y-Z space of the golf ball.

Such a method of deriving the trajectory of the golf ball is just one example, but the present disclosure is not limited thereto, and the trajectory of the golf ball may be derived by various methods. For example, the camera unit 180 may derive the trajectory of the golf ball by sensing the position where the golf ball hits the screen according to the user's swing.

On the other hand, the golf lesson data may be about lesson contents by an actual professional golfer.

Since the golf lesson data expresses a lesson made by the actual professional golfer as visual information and auditory information, the user can receive the golf lesson with more confidence.

In this instance, the user may select a desired professional golfer among a plurality of actual professional golfers displayed on the display 160 by manipulating an input unit (not shown), such as a mouse, a keyboard, or a touch screen. Accordingly, the processor 120 may read golf lesson data corresponding to the selected professional golfer from the memory 130 and provide it to the user.

The input unit may be connected to the input/output interface 150 or perform Bluetooth communication through the communication interface 170, but the present disclosure is not limited thereto.

In addition, the processor 120 may analyze images of the golf ball hit by the user to check a change in ball flight pattern of the golf ball after providing the golf lesson data to the user.

The user selects a desired ball flight pattern through the input unit, and the processor 120 may store the ball flight pattern initially selected by the user in the memory 130. The user may hit the golf ball with the golf club, and the camera unit 180 may photograph the golf ball. The processor 120 may derive the ball flight pattern of the golf ball by analyzing the captured images of the golf ball. The processor 120 may compare the initially selected ball flight pattern with the derived ball flight pattern, read golf lesson data from the memory 130 to correct the derived ball flight pattern as the initially selected ball flight pattern, and provide the golf lesson data to the user. Thereafter, the user hits the golf ball with the golf club again with reference to the golf lesson data, and the camera unit 180 may secondly capture images of the golf ball. The processor 120 may check a change in ball flight pattern by analyzing the secondly captured image of the golf ball to check whether the ball flight pattern of the golf ball has been corrected into the initially selected ball flight pattern.

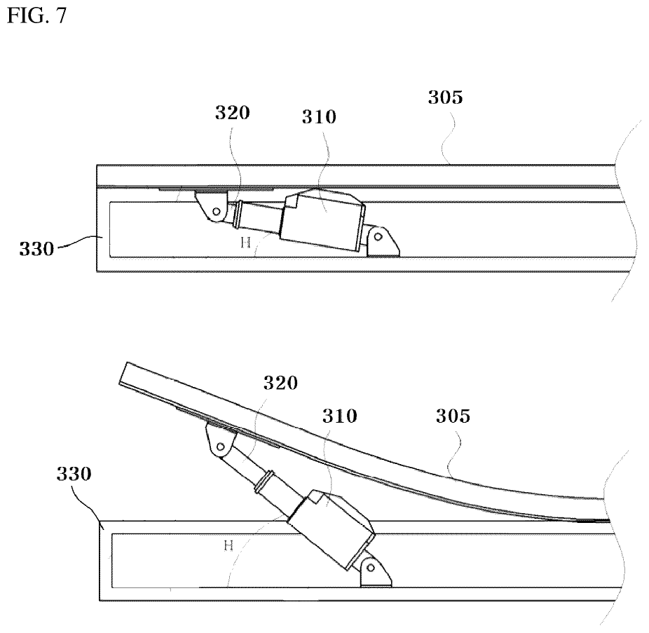

On the other hand, as illustrated in FIGS. 6 and 7, the apparatus 101 for providing golf lessons according to the embodiment of the present disclosure may further include a variable plate unit 300 having a plate 305 on which a user and a golf ball is put and an actuator 310 connected with the plate 305 to transform the shape of the plate 305. Furthermore, the variable plate unit 300 may include a frame part 330 on which the actuator 310 is installed.

The plate 305 is made of a material having elasticity capable of being transformed and restored by the actuator 310, and the shape of the plate 305 can be changed to form a curved surface. Accordingly, it is possible to form a curved surface corresponding to golf course topography information.

The actuator 310 may be driven by pneumatic pressure, hydraulic pressure, or electricity, and the processor 120 may control pneumatic pressure, hydraulic pressure, or electricity applied to the actuator 310.

As illustrated in FIG. 6, the variable plate unit 300 includes four actuators 310 respectively provided at the four corners of the plate 305, but the present disclosure is not limited to the number and installation position of the actuators 310. For example, the actuators 310 may be respectively provided at the corners of the plate 305, and another actuator 310 may be provided at the center of the plate 305. Therethrough, the variable plate unit 300 can not only withstand the load applied to the center of the plate 305, but also realize more diverse golf course topography information.

As illustrated in FIG. 7, the actuator 310 includes a piston 320, and may be inclinedly installed between a frame portion 330 and the plate 305 in a rotatable manner. In a case in which the piston 320 is withdrawn, the actuator 310 is gradually rotated so that an installation angle H of the actuator 310 formed with respect to the frame portion 330 and the plate 305 gradually increases, and a portion of the plate 305 on which the actuator 310 is installed may gradually rise upward.

The processor 120 may control the shape deformation of the plate 305 by controlling the actuator 310 according to the golf course topography information, and read golf lesson data according to the golf course topography information from the memory 130 to provide the data to the user.

The golf course topography information may be information related to the topography of an actual golf course. For example, the golf course topography information may include information on a slope or a curvature of the field of the actual golf course, but is not limited thereto.

In addition, the golf course topography information may be information related to the topography of a golf course where an actual golf tournament was held. For example, the golf course topography information may be topography information of a golf course where at least one among the Korean Men's Professional Golf Tour KPGA, the Korean Women's Professional Golf Tour KLPGA, the American Men's Professional Golf Tour PGA, and the American Women's Professional Golf Tour LPGA were held.

Accordingly, the user can receive more realistic golf lessons. In addition, the user can practice in advance in situations similar to a golf course that the user intends to play actually.

Meanwhile, the camera unit 180 photographs images of the golf ball that the user hits with the golf club on the plate 305, and the processor 120 derives the trajectory of the golf ball by analyzing the image of the golf ball photographed by the camera unit 180, and reads golf lesson data according to the golf course topography information and the trajectory of the golf ball from the memory 130, and provides the golf lesson data to the user.

For example, a short game of golf means a game at a short distance, and the user may perform an approach shot with a club for a short distance (e.g., pitching wedge, approach wedge, or sand wedge) in the short game. That is, the short game is to bring the golf ball as close as possible to a pin within a distance of 30 to 80 yards.

In order to improve the short game ability, the user must grasp the topography of the field and send the golf ball to a desired area. The present disclosure may realize a curved surface similar to the topography of the field through the variable plate unit 300, and can determine whether the golf ball is in an area desired by the user by deriving the trajectory of the golf ball.

In addition, the present disclosure can improve the user's short game ability by providing golf lesson data according to the golf course topography information and the trajectory of the golf ball to the user. Since how to derive the trajectory of the golf ball has been described above in detail, the description thereof will be omitted.

In addition, the present disclosure may provide golf lesson data according to the golf course topography information, the trajectory of the golf ball, and the ball flight patterns of the golf ball to the user. Since the ball flight patterns of the golf ball and how to derive the ball flight patterns has been described above in detail, the description thereof will be omitted.

As described above, in the present disclosure, the golf lesson data may be lesson contents by an actual professional golfer, and since it has been described in detail above, the description thereof will be omitted.

Meanwhile, the golf course topography information may include information about the intensity of hydraulic pressure or pneumatic pressure applied to a cylinder of the actuator 310. As described above, the shape of the plate 305 may be determined according to the drawn length of the piston. Accordingly, the golf course topography information may include information about the intensity of hydraulic pressure or pneumatic pressure applied to a cylinder of the actuator 310.

Meanwhile, the golf lesson data may include golf lesson data using one among pitching wedge, approach wedge, or sand wedge used on the plate 305 by the user.

As described above, since the user may use clubs for a short distance, such as pitching wedge, approach wedge, and sand wedge, in a short game, the golf lesson data may also relate to the correct use of such clubs.

The user may set a short game club that the user will use through the input unit, and the processor 120 may read golf lesson data corresponding to the short game club from the memory 130 and provide the user with the golf lesson data.

As described above, while the present invention has been particularly shown and described with reference to exemplary embodiments thereof, it will be understood by those of ordinary skill in the art that that the present disclosure can be embodied in other specific forms in addition to the above-described embodiments without departing from the spirit or scope of the present disclosure. Therefore, the above-described embodiments should be considered only as examples in all aspects and not for purposes of limitation, and the present disclosure is not limited to the above embodiments and may vary within the scope of the appended claims and their equivalents.

1. An apparatus for providing golf lessons, comprising:
a camera unit configured to photograph images of a golf ball hit by a user with a golf club;
a memory configured to store golf lesson data according to ball flight patterns of the golf ball; and
a processor for analyzing the images of the golf ball captured by the camera unit to derive the ball flight patterns, reading the golf lesson data according to the ball flight patterns from the memory, and providing the read golf lesson data to the user.

2. The apparatus according to claim 1, wherein the camera unit photographs images of the golf ball with a marking formed on its surface, and the processor analyzes the images of the golf ball captured by the camera unit to derive the ball flight pattern of the golf ball according to rotation information of the marking.

3. The apparatus according to claim 2, wherein the processor derives the ball flight patterns of the golf ball according to the movement trajectory of the golf ball and the rotation information of the marking by analyzing the images of the golf ball captured by the camera unit.

4. The apparatus according to claim 1, wherein the golf lesson data is about lesson contents by an actual professional golfer, and
wherein the processor analyzes the images of the golf ball hit by the user to check a change in ball flight pattern of the golf ball after providing the golf lesson data to the user.

5. The apparatus according to claim 1, further comprising:
a variable plate unit having a plate on which a user and a golf ball is put and an actuator connected with the plate to transform the shape of the plate,
wherein the processor controls the shape deformation of the plate by controlling the actuator according to the golf course topography information, and reads golf lesson data according to the golf course topography information from the memory to provide the data to the user.

6. The apparatus according to claim 5, wherein the camera unit photographs images of the golf ball that the user hits with the golf club on the plate, and the processor derives the trajectory of the golf ball by analyzing the image of the golf ball photographed by the camera unit, and reads the golf lesson data according to the golf course topography information and the trajectory of the golf ball from the memory, and provides the golf lesson data to the user.

7. The apparatus according to claim 6, wherein the golf course topography information includes information about the intensity of hydraulic pressure or pneumatic pressure applied to a cylinder of the actuator.

8. The apparatus according to claim 6, wherein the golf lesson data includes golf lesson data using one among pitching wedge, approach wedge, or sand wedge used on the plate by the user.
